(19) United States
(12) Patent Application Publication
(10) Pub. No.: US 2024/0071238 A1
(43) Pub. Date: Feb. 29, 2024

(54) INTEGRATED INFORMATION STICK

(71) Applicants: Patrick A. Race, Bay City, MI (US); Josh Stover, Alpharetta, GA (US); Jason Daenzer, Tucker, GA (US); Kiel Schultheiss, Clarkston, GA (US)

(72) Inventors: Patrick A. Race, Bay City, MI (US); Josh Stover, Alpharetta, GA (US); Jason Daenzer, Tucker, GA (US); Kiel Schultheiss, Clarkston, GA (US)

(21) Appl. No.: 18/476,767

(22) Filed: Sep. 28, 2023

Related U.S. Application Data
(63) Continuation-in-part of application No. 17/822,286, filed on Aug. 25, 2022, now abandoned.

(51) Int. Cl. G09B 1/02

(52) U.S. Cl. CPC G09B 1/02

(57) ABSTRACT

Integrated information stick that uses details about cultural and economic issues and presents graphically essential data, with the goals of creating a symbol and a teaching tool to help create and support efforts to affect change in individual issues. The device is comprised of a base, a top, and intervening washers in different colors and sizes to represent issues of the day.

### CROSS-REFERENCE TO RELATED APPLICATIONS

This application is a Continuation-in-Part of utility application Ser. No. 17/822,286, filed Aug. 25, 2022, from which priority is claimed.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The integrated information stick of this invention uses details about cultural and economic issues and presents graphically essential data, with the goals of creating a symbol and a teaching tool to help create and support efforts to affect change in individual issues.

Information sticks can be found in ancient cultures such as the Australian Aboriginal message stick that traditionally were solid pieces of wood of varying length etched with angular lines and dots used by indigenous Australians.

In modern America, woodland information sticks are used to measure tree heights and estimate the merchantable height of a tree. The stick consisted of a flat piece of wood that had numbers and certain distances embedded in the surface.

Certain patents deal with more modern representations of jewelry and are not necessarily information providing devices. Thus, jewelry is suspended on a common chain or rope such as in U.S. Pat. No. 8,627,682 that issued to Kleanthis Christodoulou on Jan. 14, 2014.

Design Pat. D914,529 that issued to Karen Green, et. al. on Mar. 30, 2021, deals with an ornamental design for interchangeable jewelry.

U.S. design Pat. D885,599, that issued to Guerizec on May 26, 2020, deals with an ornamental design for a modular stick. The device is not a message device.

U.S. Pat. No. 10,264,826, that issued to Ratcliff on Apr. 23, 2019, deals with a sectional bra system that deals with a bra and related jewelry components that can be interconnected in various ways. It is not a message device.

### BRIEF SUMMARY OF THE INVENTION

Thus, what is disclosed and claimed in this specification is an integrated information stick. The integrated information stick comprises a foundation post, wherein the foundation post comprises an integrated elongated shaft having an enlarged base.

Also claimed is a method of using the integrated information stick.

There is a plurality of colored washers, each having a centered opening, which centered opening has a size that snugly fits on the elongated foundation post shaft.

There is a cap, the cap has a centered slot in a bottom end and the slot has a size that snugly fits on the foundation post shaft at a top of the foundation post shaft. The cap has a pre-selected size and color, and the cap has a through opening near a top end. The washers and the enlarged base have pre-selected sizes and colors.

In another embodiment, there is a modified integrated information stick, comprising two or more integrated information sticks attached to each other. Each of the integrated information sticks comprise a foundation post wherein the foundation post comprises an elongated shaft having an enlarged base.

There is a plurality of colored washers, each having a centered opening, which centered opening has a size that snugly fits on the foundation post shaft.

There is a cap, the cap having a centered slot in a bottom end and the slot has a size that snugly fits on the foundation post shaft at a top of the foundation post shaft. The cap has a pre-selected size and color, and the cap has a through opening near a top end. The washers and the enlarged base have pre-selected sizes and colors.

Each of the enlarged bases and each of the caps have at least two openings therein to receive pegs.

### BRIEF DESCRIPTION OF THE SEVERAL VIEWS OF THE DRAWING(S)

FIG. 1 is a full front view of the foundation post with an elongated shaft having an enlarged base.

FIG. 2 is a rendition of an environmental stick.

FIG. 3 is an exploded view of the stick of FIG. 2.

FIG. 4A is a top view of a washer showing the centered opening.

FIG. 4B a top view of a washer that does not have a regular outside surface.

FIG. 5 is an end view of a cap of this invention showing the through hole for a lanyard and an opening for a peg.

FIG. 6 is a full front view of two joined sticks.

### DETAILED DESCRIPTION OF THE INVENTION AND DRAWINGS

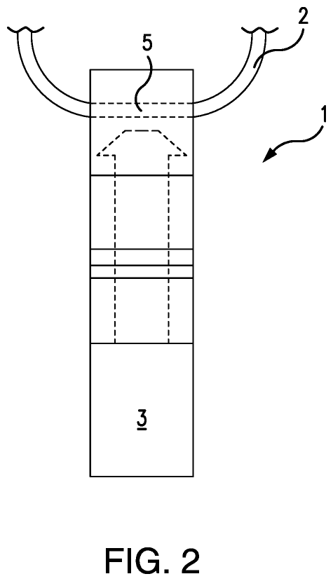

Turning now to FIG. 2, there is shown a full rendition of a stick 1 which is an example of the types of sticks that can be formatted within this invention.

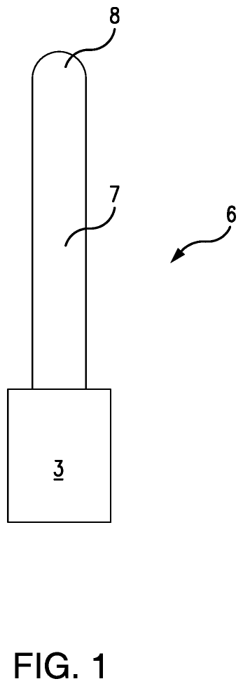

There is shown the stick 1, a lanyard 2 (not part of this invention) in a full front view. Also shown is a foundation post base 3 (see FIG. 1), washers of various sizes 4 and in phantom, the through hole 5 for the lanyard 2.

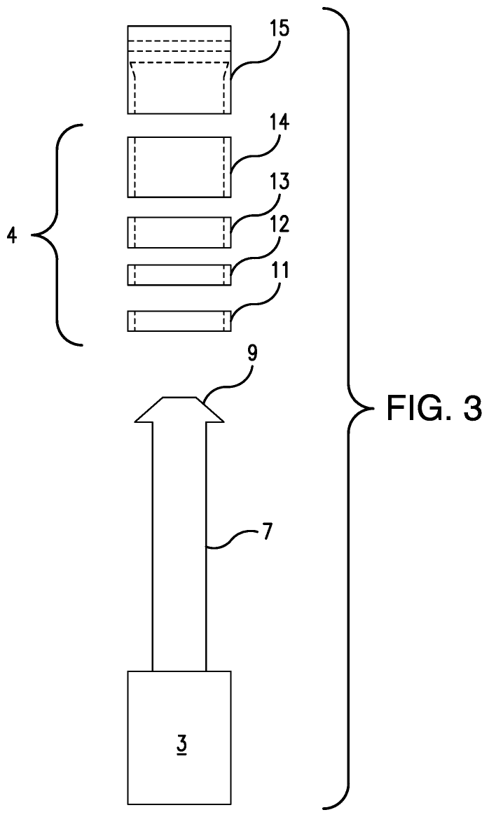

FIG. 1 shows a foundation post 6, the foundation post 6 comprised of an elongated shaft 7 and the enlarged base 3. The foundation post 6 can have any type of terminal end 8 (smooth, rounded) as shown in FIG. 1 and FIG. 3 (hooked top 9).

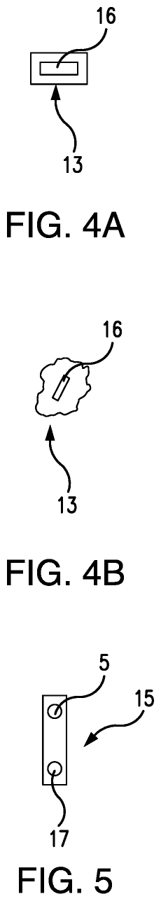

There is a plurality of washers (four shown in the Figures, but the invention is not limited to 4) and in FIG. 3, they are numbered 11, 12, 13, and 14 and the top is designated 15. The washers have a centered opening and shown in the drawings is a rectangular shaped washer (FIG. 4A) with a rectangular shaped centered opening. However, it is contemplated within the scope of this invention to use washers having any configuration, such as round, square, rectangular, triangular, trapezoidal, serrated surface, and the like. It is also, contemplated within the scope of this invention to use washers whose centered openings can have any configuration such a those mentioned just Supra just as long as all washers on the elongated shaft have the same configuration for a centered opening.

For the environmental stick (climate stick), the colors are designated as 15 top red, 14 as yellow, 13 as black, 12 as yellow, 11 as black and the base 3 as green.

By way of example, this stick can be formatted as: Green (FIG. 3, designated 3): 275 ppm of CO2 in the earth's atmosphere from 10,000 years ago to the year 1804. Human population was about 4 million 10,000 years ago and about 1 billion in 1804.

The black (FIG. 3, designated 11) is added CO2 from burning carbon from 1804 to 2022 which consisted of 275 ppm to 422 ppm. There are 8 billion people in 2022.

The yellow section (FIG. 3, designated 12) in the black section represents 350 ppm in 1988. The yellow section (FIG. 3, designated 14) below the red cap (FIG. 3, designated 15) is 20 to 25% of that of red wherein red plus the yellow wherein that sum designates the amount of CO2 if all known carbon in the ground is burned. The combined yellow and red represent all carbon fossil fuel companies and countries that claim they will burn to give us the energy we will need by 2050. Climate scientists state that burning 20 to 25% will end civilization.

FIG. 4A is a full top view of a washer of this invention, for example 14, showing the centered through hole 16. FIG. 4B illustrates a washer that is serrated around the outside surface. In addition, FIG. 5 shows the top 15 side view and the through hole 5 for the lanyard 2 and an opening for a peg.

The washers, cap, and base can be any size and can be designated any color to fit the particular message that one wishes to exhibit with the stick.

There is a method of using an integrated information stick to allow for displaying statistical and physical information concerning physical and social entities by displaying graphically the relationship of component parts of said integrated information stick.

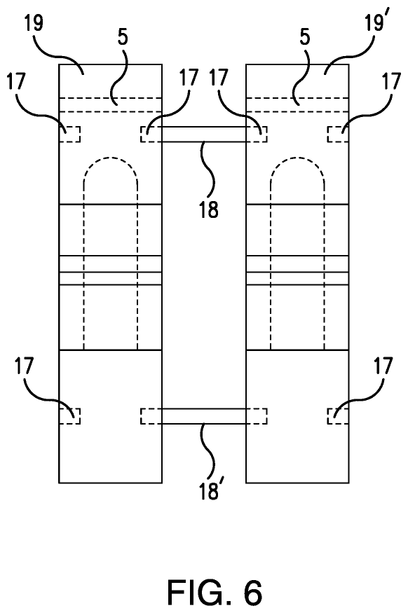

Turning now to FIG. 6 there is shown two sticks designated 19 and 19′. These sticks do not have to represent the same issues, they can be two different issues. Shown is the through hole 5 for a lanyard (not shown), openings 17 in the side for peg insertion and pegs 18 and 18′ used to attach the two sticks together. The pegs can be manufactured from metal, plastic or wood and can be any desired length.

The stick can convey messages for a woman's information stick that represents the view of how much the threat of negative behavior, that is, abuse, rape or death toward women exists. Most people do not understand how prevalent this fear if for women. The women's stick invites people to join the mass movement to protect girls and women.

The labor information stick deals with those who are members of labor unions that realize certain benefits that have been won by long and hard organizing. Once the elections are won it is difficult to show the value of the struggle to those outside the labor union. The labor information stick invites people to join the mass movement to make unions stronger and more widely distributed in the world.

The poverty/equity information stick is one that is the most difficult to address regarding problems with systems that are in place such as tax laws and/or good old boy relationships that distribute the rewards of corporation organization output to only a few and leave more of our people underhoused, underfed and medically uncared for. The poverty/equity information stick invites people to join the mass movement to reduce the wealth gap and more equally distribute the goods and service all people need.

The climate stick (environmental stick) presents the data on the rapid rise of CO2 in the atmosphere due to burning fossil fuels. The climate stick invites people to join the mass movement to end the burning of carbon.

The reparations stick for Afro-American issues, woman's reproduction information stick, food stick for basic good nutrition information and any other set of information desired by a group or company can be the basis for a good story to advance the concept.

It is preferred for this invention to manufacture the sticks from plastic, and most preferred is a bio-based plant plastic. Information on such a material can be found at: https://U.S.Polymaker.com/products/polyterra-pla.

The devices of this invention are generally configured such that the washers 13 and the top 15 fit the elongated shaft with a small amount of friction. The top can be snapped into place if the terminal end is a fork, or the cap can be glued on the elongated shaft.

If the top 15 is held frictionally, then the scheme can be altered to fit a new scenario or updated scenario.

1.-13. (canceled)

14. A method of using an integrated information stick to allow for displaying statistical and physical information concerning physical and social entities by displaying graphically the relationship of component parts of said integrated information stick, said integrated information stick comprising:
i. a foundation post, said foundation post comprising an elongated shaft having an enlarged base;
ii. a plurality of colored washers, each having a centered opening, which centered opening has a size that snugly fits on said foundation post shaft;
iii. a cap, said cap having a centered slot in a bottom end, said slot having a size that snugly fits on said foundation post shaft at a top of said foundation post shaft, said cap having a pre-selected size and color, said cap having a through opening near a top end; said washers and said enlarged base having pre-selected sizes and colors.

15. The method as claimed in claim 14 wherein the color scheme for the cap, washers, and base of said integrated information stick are predetermined.

16. The method as claimed in claim 14 wherein the component parts of the integrated information stick are manufactured from a material selected from metal, wood, paper, cardboard, plastic or a combination of metal, wood, paper, cardboard, and plastic.

17. The method as claimed in claim 16 wherein the material is metal.

18. The method as claimed in claim 16 wherein the material is wood.

19. The method as claimed in claim 16 wherein the material is paper.

20. The method as claimed in claim 16 wherein the material is cardboard.

21. The method as claimed in claim 16 wherein the material is plastic.

22. The method as claimed in claim 21 wherein the material is plant based plastic.

23. The method as claimed in claim 21 wherein the plastic is polyethylene.

24. The method as claimed in claim 21 wherein the plastic is polypropylene.

25. The method as claimed in claim 21 wherein the plastic is a plant-based plastic.

26. A method as claimed in claim 14 wherein said modified integrated information stick, comprises two or more integrated information sticks attached to each other, each said integrated information stick comprising:
i. a foundation post, said foundation post comprising an elongated shaft having an enlarged base;
ii. a plurality of colored washers, each having a centered opening, which centered opening has a size that snugly fits on said foundation post shaft;
iii. a cap, said cap having a centered slot in a bottom end, said slot having a size that snugly fits on said foundation post shaft at a top of said foundation post shaft, said cap having a pre-selected size and color, said cap having a through opening near a top end; said washers and said enlarged base having pre-selected sizes and colors;
iv. each said enlarged base and each said cap having at least two openings therein to receive pegs.
